(19) United States
(12) Patent Application Publication
(10) Pub. No.: US 2008/0063189 A1
(43) Pub. Date: Mar. 13, 2008

(54) OPTIMAL SIGNED-DIGIT RECODING FOR ELLIPTIC CURVE CRYPTOGRAPHY

(75) Inventors: RAJENDRA KATTI, FARGO, ND (US); XIAOYU RUAN, Fairfax, VA (US)

Correspondence Address: JOHN P. O'BANION;O'BANION & RITCHEY LLP, 400 CAPITOL MALL SUITE 1550, SACRAMENTO, CA, 95814, US

(73) Assignee: NORTH DAKOTA STATE UNIVERSITY, FARGO, ND (US)

(21) Appl. No.: 11/558,762

(22) Filed: Nov. 10, 2006

Related U.S. Application Data
(63) Continuation of application No. PCT/US05/11235, filed on Apr. 4, 2005.
(60) Provisional application No. 60/572,073, filed on May 17, 2004.
(60) Provisional application No. 60/570,255, filed on May 11, 2004.

(51) Int. Cl. H04L 9/30; G06F 7/523

(52) U.S. Cl. 380/30; 708/625

(57) ABSTRACT

An apparatus and method is described of reducing joint weight for integers involved in a scalar multiplication, such as during cryptography. By way of example, the method is utilized within elliptic curve cryptography (ECC), wherein reducing joint weight speeds the execution of the scalar multiplication and reduces memory overhead. Generally, the recoding technique of the present invention involves generating a binary signed-digit representation for the two or more non-negative integers and then replacing groups of the binary signed-digits from left to right according to a predetermined pattern in order to reduce joint weight. The recoding process of the present invention is performed in a left-to-right order which is compatible with the order of the scalar multiplication. The present method reduces the amount of memory required for performing cryptography and allows it to be implemented in hardware or any desired combination of hardware and software.

### CROSS-REFERENCE TO RELATED APPLICATIONS

This application claims priority from, and is a 35 U.S.C. § 111 (a) continuation of, co-pending PCT international application serial number PCT/US2005/011235, filed on Apr. 4, 2005, incorporated herein by reference in its entirety, which designates the U.S. and which claims priority from U.S. provisional application serial number 60/572,073, filed on May 17, 2004, incorporated herein by reference in its entirety, and from U.S. provisional application serial number 60/570,255, filed on May 11, 2004, incorporated herein by reference in its entirety. Priority is claimed to each of the foregoing applications.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to cryptography, and more particularly to elliptic curve cryptosystems.

2. Description of Related Art

Public-key cryptography is an important technology being increasingly utilized in a wide variety of applications, including but not limited to smart-cards, e-commerce security, wireless sensors, cellular phones, internet security, and other encryption applications implemented in hardware and/or software. It should be appreciated that many of these applications, and numerous other applications not listed, require a cryptographic method which provides high security, yet is readily implemented with minimal hardware and/or computational resources.

Public-key encryption uses a combination of a private key and a public key. The private key is known only to the device (i.e. computer) while the public key is given out by the device (i.e. computer) to any computer that wants to communicate securely with it. To decode an encrypted message, a receiving device (i.e. computer) must use the public key provided by the originating device and its own private key.

Public-key cryptographic algorithms usually require very long data word lengths, such as greater than 160 bits. The long word length taxes the processor executing the cryptographic algorithms making these techniques impractical for many commercial applications.

One of the most popular public-key cryptographic solutions is the elliptic curve cryptosystem (ECC). ECC is known to provide high security because it depends on the discrete logarithm problem needing fully exponential time for a solution. ECC also has lower key sizes and hence has the potential for low hardware overhead. The main operation in ECC is the computation of kP, where k is an integer and P is a point on an elliptic curve. The ECC is actually computed as a scalar multiplication, />

$${\sum }_{i = 0}^{N - 1} {k}_{i} {P}_{i}$$

where kᵢ, values are integers and Pᵢ values are points on an elliptic curve. Digital signatures are also verified using this computation.

The elliptic curves considered herein are defined over a finite field of characteristic two. Digital signatures are verified using a computation of the form gP+hQ, where g and h are integers and P and Q are points along the elliptic curve. Computing kP, which is commonly utilized in all ECC protocols, can also be expressed as gP +hQ, where k=g +h2s and Q=2 P. The joint weight of g and h determines the speed of computing gP +hQ. Joint weight can be generally understood as follows.

In computing the joint weight of g and h, the binary values of g and h are written one below the other and joint weight is the number of non-zero columns. For example, consider finding the joint weight of 53 and 102.

53=0 1 1 0 1 0 1 102=1 1 0 0 1 1 0

### The joint weight of 53 and 102 is 6, by virtue of the number of columns that are non-zero.

The above illustrates joint weight in a traditional binary number system using two digits, 0 and 1, to represent non-negative integers. For example the integer 23 is denoted in binary as (101 11), which is given by:

23 =1x2⁴ +Ox2³ +1x2² +1x2¹ +1x2o

However, in a signed-binary number system, the values 0, 1 and -1 may be utilized to represent non-negative numbers. The value of 23 can be represented in a number of equivalent forms, including the following:

23 =(11001) because 23 =1x2⁴ +1x2³ +0x2² +0x2¹ +(-1)x2o OR 23 =(11011) because 23 =1x2⁴ +1x2³ +0x2² +(-1)x2¹ +1x2o

The “weight” of a given representation is considered to be given by the number of non-zero digits in the representation. By way of example (10111) has a weight of four (4); (11001) has a weight of three (3); and (11011) has a weight of four (4). It should be noted that since the signed-binary representations of a non-negative integer vary, their weights also vary. Less weight suggests faster computation in elliptic curve cryptography, wherein the signed-binary value (11001) can be computed faster than either (10111) or (1 1011) .

In portions of the computation the integers can be written as columns of signed-binary bits within integer rows. Consider an example with the integers 23, 15 and 7. Each of these numbers can be represented in more than one signed-binary representation. Different representations for the integers 23, 15 and 7 are considered below.

$$[ \begin{matrix}23 \\ 15 \\ 7\end{matrix} ] = [ \begin{matrix}1100 \overline{1} \\ 1000 \overline{1} \\ 0100 \overline{1}\end{matrix} ] = [ \begin{matrix}10111 \\ 01111 \\ 0100 \overline{1}\end{matrix} ] = [ \begin{matrix}110 \overline{1} 1 \\ 1000 \overline{1} \\ 0100 \overline{1}\end{matrix} ] = …$$

The first signed-binary table has a joint weight of three (3), the second table has a joint weight of (5), and the third table has a joint weight of four (4).

Similar to the case for a single integer, reduced joint weight increases the performance (less overhead) of the elliptic curve cryptographic operations.

It is beneficial to reduce the hardware and/or software overhead associated with these systems for minimizing the cost to implement applications. The present invention fulfills that need as well as others and overcomes the drawbacks of conventional approaches.

Accordingly, a need exists for enhanced methods of computing minimum joint weight integer representations prior to executing scalar multiplications, such as in performing elliptic curve cryptography. The present invention fulfills that need as well as others and overcomes the drawbacks of prior solutions.

### BRIEF SUMMARY OF THE INVENTION

The present invention is directed at speeding scalar multiplication, such as utilized within cryptography, for example elliptic curve cryptography (ECC).

The method provides new recoding methods for generating signed-binary representations of non-negative integers having minimum joint weights. The reduced joint weights speed scalar multiplication, such as elliptic curve computations association with elliptic curve cryptographic (ECC) systems.

The present inventive methods consider the importance of computation direction, which is a factor that has not been fully appreciated in the industry.

In arriving at the present invention it has been recognized that traditional methods of computing minimum-weight signed-binary representations operate from the least significant bit to the most significant bit, which can also be referred to as a right-to-left computation order. However, the direction of operation during scalar multiplication, such as when performing elliptic curve cryptography, is from left-to-right. As a result, ECC systems are currently subject to additional overhead during integer recoding and are also not readily amenable to hardware acceleration, such as the use of digital sequential circuits to execute all or portions of the computations.

The present invention describes a recoding method which is well-suited for use in public-key cryptosystems and particularly elliptic curve cryptography. Integers are converted to signed-digit representations {O, 1, -1} with digit replacement performed in response to minimization of joint weight.

A scalar multiplication, such as part of elliptic curve cryptography, can be performed during the scanning. The method utilizes left to right scans, in which scanning is performed from most significant bit (MSB) to least significant bit (LSB) of ki when computing

$${\sum }_{i = 0}^{N - 1} {k}_{i} {P}_{i}$$

the scan with the multiplication to reduce memory requirements.

The invention is amenable to being embodied in a number of ways, including but not limited to the following descriptions.

An embodiment of the invention can be described as an apparatus for recoding non-negative integers to reduce joint weight, such as associated with a scalar multiplication, comprising: (a) means for latching at least three binary bits received as integer input; (b) means for generating a signed-binary intermediate (ISBR) representation in response to receiving binary bits from the means for latching; (c) means for generating a signed-binary output (OUT) representation in response to receiving binary bits from the means for latching; (d) means for comparing the ISBR bits with previous OUT bits; and

(e) means for selecting either ISBR bits or OUT bits as integer output in response to the comparison performed by the means for comparing. The reduced joint weight of the integer output from the selecting means can be useful for a number of applications, such as for reducing the overhead to which a scalar multiplication is subject. It should be appreciated that the apparatus can be readily embodied as a hardware-based apparatus because both the technique of recoding and of performing a scalar multiplication are performed from left to right (MSB to LSB). The technique thus leads to significantly reducing the amount of circuitry required in cryptographic system or other applications that can benefit from reduced joint weight prior to a scalar multiplication.

One embodiment of the invention can be described as a method of recoding non-negative integers to reduce joint weight for performing scalar multiplication during cryptography, comprising: (a) generating a binary signed-digit representation of at least two non-negative integers; and (b) replacing groups of binary signed-digits having reducible bits in response to scanning the binary signed digits from a most significant bit to a least significant bit to reduce the joint weight. The reduction of joint weight which is provided reduces the overhead of scalar multiplication, such as performed within ECC systems.

An embodiment of the invention can be described as an apparatus for recoding non-negative integers to reduce joint weight associated with a scalar multiplication, comprising: (a) an array of latches configured for receiving at least three binary bits received as integer input; (b) an intermediate signed-binary representation (ISBR) generator configured for generating signed- binary intermediate values in response to receiving binary bits from the array of latches; (c) an output (OUT) generator configured for generating signed-binary output values in response to receiving binary bits from the array of RFT-126-3US 6 latches; (d) a comparison circuit configured for generating a control signal in response to comparing bits generated from the ISBR generator with bits previously generated by the OUT generator; and (e) a multiplexer having inputs coupled to the output of the ISBR generator and the OUT generator and configured for outputting bits from the selected source in response to the control signal from the comparison circuit. [0026] Another embodiment of the invention can be described as a method of recoding non-negative integers to reduce joint weight for performing scalar multiplication during cryptography, comprising: (a) generating a signed binary representation of each integer ki, wherein (O <i <N-1), into an (L +1) -bits {0,1,-1} -based representation according to ki =((kitLe -0)I(ki,L-₂ -ki,L-1) (ki,O -kil ),(o-ki,o)); (b) scanning all the (L +1) columns in the array from the left-most column to the right-most column (0), wherein each column has N entries; (c) marking rows which have a non-zero bit, “reducible bit”, in the column being scanned if all the N entries in the column being scanned are non-zero; (d) scanning the marked rows from the reducible bit rightwards, scanning N bits at the most; (e) skipping a column and continuing to scan the next column to its right if the rightward non-zero bit for at least one marked row is not within the next N bits; (f) establishing a maximum distance between the reducible bit and the next rightward non-zero bit at (c-1) if the next rightward non-zero bit for all marked rows is within the next N bits among all marked rows; (g) scanning columns in a right-to-left sweep of (C +1) bits from the column with the farthest non-zero bit found in Step (f) to the column with reducible bits; (h) skipping a column and continuing to scan the next column to its right if at least one column among the (C+1) columns is zero; (i) replacing bits if all the (C+1) columns are non-zero and there exists at least one non-zero entry in each of the (C+I) columns being scanned; wherein the replacing comprises replacing x by 0, supposing that the reducible bit in one marked row is xe II,-II, followed by replacing rightward bits by x until the next non-zero bit x-which is also replaced by x; and (1) skipping columns and continue to scan backwards until arriving at the right-most column; (k) whereby the recoding of the binary signed-digits reduces joint weight and the overhead associated with performing a scalar multiplication. It should be appreciated that the (L+1) signed binary representation of k, is generated from the traditional L-bit binary representation.

Another embodiment of the present invention can be described as a method of performing scalar multiplication within a public-key cryptosystem, comprising: (a) generating a binary signed-digit representation of non- negative integers k,; (b) recoding the binary signed-digit representation in response to scanning integers from a most significant bit (MSB) to a least significant bit (LSB); (c) sequentially performing a scalar multiplication of the integers k, along an elliptic curve as each integer is scanned from most significant bit (MSB) to least significant bit (LSB); (d) wherein the scalar multiplication is given by

$${\sum }_{i = 0}^{N - 1} {k}_{i} {P}_{i}$$

in wnicn ki are integers and Pi are points along a curve. The signed digit representations are represented with {0, 1 and -1 } instead of a binary representation with {0 and 1 }. By way of example, the conversion of the integers to a signed binary form can be performed using a signed binary multiplication technique, such as a Booth multiplication.

Another embodiment of the present invention can be generally described as a method of computing a binary signed digit representation of two integers g and h, each having L bits, comprising: (a) converting binary representations of at least two integers g and h into Xl and X₂ according to:

Xi =((gL l 0)I(gL-2 - gL-),...,(go -gl), (-go)) and X₂=((hk₁ - O), (hk₂ -kh-),...,(ho -kh),(O-ho)); and (b) converting Xl and X₂ into Y, and Y2 using left-to-right replacement if decreased joint weight can be produced; wherein the left-to-right replacement comprises,

replacing 1, -1 by 0,1,

replacing -1,1 by 0, -1,

replacing 1, 0, -1 by 0,1,1,

replacing -1, 0,1 by 0, -1, -1,

replacing 0, -1, -1 by -1, 0,1,

replacing 0,1,1 by 1, 0, -1.

A scalar multiplication may be performed in conjunction with the recoding method to facilitate a scalar multiplication, such as within ECC systems. During the conversions, only three signed-bits of memory are required for each integer, while the resultant joint weight optimization is equivalent to that produced using joint sparse form (JSF) techniques. The joint weight of g and h is determined by the number of non-zero columns when g and h are aligned in adjacent rows. Typically, the size of integers g and h are each at least 160 bits, although the technique may be utilized with integers of arbitrary length.

The new representation may be utilized in performing a scalar multiplication along an elliptic curve as each integer is converted. The method can be implemented in hardware or software. For example in hardware it may be implemented as a sequential circuit having bits of g and h as inputs with the most significant bits being input first. The technique may be utilized with any desired number of inputs.

The present invention provides a number of beneficial and advantageous aspects, including but not limited to the following.

An aspect of the invention is that of simplifying scalar multiplication; in particular those associated with the execution of elliptic curve cryptography (ECC).

Another aspect of the invention is to provide a method by which the binary signed-digit recoding for optimal joint weight may be performed with reduced memory overhead.

Another aspect of the invention is to provide a method by which the binary signed-digit recoding may be performed in a left-to-right order making it compatible with the order that scalar multiplications are performed within the ECC system.

Another aspect of the invention is a hardware apparatus for performing binary signed-digit recoding.

Another aspect of the invention is to provide a recoding method which can be practiced with two or more integers.

A still further aspect of the invention is to provide a digit recoding method which is suitable for use in recoding integers having long word sizes, in particular those with word lengths greater than 160 bits.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a flowchart of a general process of performing binary signed- digit recoding for elliptic curve cryptography according to an embodiment of the present invention.

FIG. 2 is a flowchart of a method of performing binary signed-digit recoding for elliptic curve cryptography according to another embodiment of the present invention, showing the replacement patterns for a two integer case.

FIG. 3 is a flowchart of a method of performing binary signed-digit recoding for elliptic curve cryptography according to another embodiment of the present invention, showing replacements performed for L binary columns within N rows of integers.

FIG. 4 is a flowchart of a method of performing binary signed-digit recoding for elliptic curve cryptography according to another embodiment of the present invention, showing in detail how replacements are performed.

FIG. 5 is a flowchart of software performing signed-digit recoding for elliptic curve cryptography according to another embodiment of the present invention.

FIG. 6 is a flowchart of hardware steps for performing signed-digit recoding for elliptic curve cryptography according to another embodiment of the present invention.

FIG. 7 is a block diagram of hardware for performing signed-digit recoding for elliptic curve cryptography according to another embodiment of the present invention, shown for use in recoding three binary bits.

FIG. 8 is a block diagram of hardware for performing signed-digit recoding for elliptic curve cryptography according to another embodiment of the present invention, shown for use in recoding N-integers.

### DETAILED DESCRIPTION OF THE INVENTION

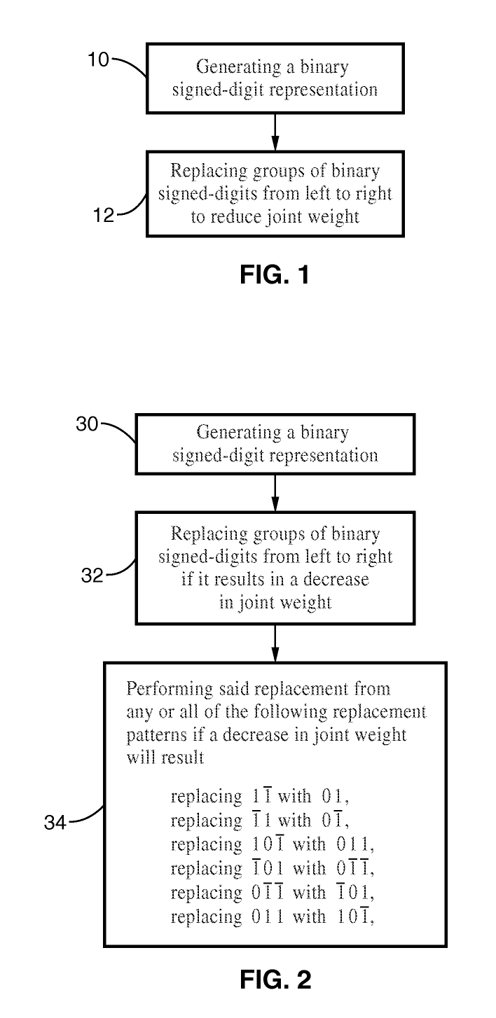

Referring more specifically to the drawings, for illustrative purposes the present invention is embodied in the apparatus generally shown in FIG. 1 through FIG. 8. It will be appreciated that the apparatus may vary as to configuration and as to details of the parts, and that the method may vary as to the specific steps and sequence, without departing from the basic concepts as disclosed herein.

A recoding method is described which is well-suited for use in public- key cryptosystems and particularly elliptic curve cryptography. Integers are converted to signed-digit representations {O, 1, -1} with digit replacement performed in response to joint weight. A scalar multiplication, such as part of elliptic curve cryptography, can be performed during the scanning. The method utilizes left to right scans (most significant bit to least significant bit) of integers kᵢ when computing

$${\sum }_{i = 0}^{N - 1} {k}_{i} {P}_{i}$$

and combining the scan with the multiplication to reduce memory requirements.

$${\sum }_{i = 0}^{N - 1} {k}_{i} {P}_{i}$$

It will be appreciated that in computing the integer k, values are scanned from left (most significant bit) to right (least significant bit).

Therefore, new representations are obtained during a left-to-right recoding process which can be combined with computing

$${\sum }_{i = 0}^{N - 1} {k}_{i} {P}_{i} ,$$

thereby reducing memory requirements since k, values need not be stored. It should be appreciated that since the k, integer values are large numbers, memory storage can be an important consideration in resource constrained environments, such as ECC implementations within smart cards and the like.

FIG. 1 illustrates by way of example the recoding process of the present invention in which a binary signed-digit representation is generated at block 10, followed by replacing groups (i.e. two or more digits) of the binary signed-digits in a left-to-right process as per block 12 toward reducing the joint weight. The replacements are performed from a list of possible replacements.

The left-to-right order of the process makes it compatible with the direction by which gP+hQ is computed, thereby reducing memory requirements and even allowing the cryptography solution to be performed in hardware.

A preferred method of computing gP+hQ according to an embodiment of the present invention, involves a computation which will be referred to herein as the “Shamir method” as described in the paper by T. ElGamal, “A public-key cryptosystem and signature scheme based on discrete logarithms,” The IEEE Transactions on Information Theory, Vol. 31, pp 469-472,1985.

Table 1 illustrates an example of how the computation is performed using the Shamir method. The process of recoding the integers according to the present invention is compatible with the Shamir method of performing scalar multiplication.

A number of mechanisms exist by which weight encoding may be performed in preparation for the scalar multiplication. One article describing these mechanisms is by M. Joye and S. Yen entitled “Optimal Left-to-Right Binary Signed-Digit Recoding, “IEEE Transactions on Computers 49(7):740-748, 2000. Of these mechanisms, the joint sparse form (JSF) provides optimizing of joint weight for two integers, wherein the number of non-zero digits is minimized. More recently the JSF method has been extended for use with more than two integers. However, one of the major drawbacks to the JSF method is that it utilizes considerable memory resources because it is performed in a right-to-left order. A JSF representation of two integers g and h has the following properties: JS1 - at least one bit position is a zero for both g and h for any three consecutive bit positions; JS2 - adjacent bits in g and h have opposite sign; JS3-if two consecutive digits in position j+I and j of j +1 g (or h ) are non-zero then the digit in position j +1 in h (or g ) is +1 or -1 and the digit in position j in h (or g ) is 0. The joint sparse form can thus be considered proper if at least one of its left-most bits is non-zero.

A couple of theorems are put forth with regard to the joint sparse form, however, the proofs are omitted for brevity. According to a first theorem a pair of positive integers has at most one proper joint sparse form. According to a second theorem the average joint weight among JSF representations of L-bits is L/2.

Joint sparse form (JSF) recoding of g and h is shown in the first two rows of Table 1. In order to compute 53P+102Q, according to a prior example, we must start from the left-most column and proceed toward the right-most column. The first entry in the row labeled “Double” is 1 (this is the entry in the third row of the left-most non-zero column). The entry in the third row doubles the bottom-most entry in the column to the left. The entries in the other rows of a column are formed based on the bits of g and h in that column. If the bits of g and h in a column are both -1 then the entry on the row labeled “Double” of that column is added to “-(P+Q)” of that column.

The bottom-most entry in the right-most column contains the desired computation “gP+hQ”. Accordingly, the number of additions required is dependent on the joint weight of g and h and the number of doublings required is one less than the number of bits in g or h. It should be noted that obtaining -P from P in the elliptic curve group can be done at negligible cost.

For computing gP+hQ the integers g and h are scanned from left (most significant bit (MSB)) to right (least significant bit (LSB)). Therefore the obtaining of new representations for g and h by scanning them from left-to-right is advantageous because it can be readily combined with the computing of gP+hQ. The directional compatibility between the recoding and computation stages reduces the amount of memory required to perform the computation because the new representations of gP +hQ do not have to be stored. Since g and h are large numbers (greater than 160 bits) this is a very important consideration in resource-constrained environments, such as with Smart cards, cell phones, personal digital assistants and the like.

Recoding two integers according to the JSF method results in an optimal joint weight of 0.5 n, where n is the number of bits needed to express the integers in binary form. However, the JSF method involves substantial memory overhead because it is a right-to-left method, wherein two integers g and h are fully scanned from right-to-left and their JSF stored in memory prior to the computing gP+hQ. Shamir's method involves scanning the JSF representations of g and h from left-to-right.

The following describes an algorithm according to the joint sparse form (JSF) as applied to two integers g and h.

```
Input: Non-negative integers g and h, not both zero.
Output: The joint sparse form of g and h.
Set k₀ ← g and k₁ ← h; j ← 0; d₀ ← 0; d₁ ← 0
While k₀+d₀>0 or k₁+d₁>0 do
  Set n₀ ← d₀+k₀; n₁ ← d₁+k₁
  For i from 0 to 1
      If nᵢ is even then u ← 0
      Else u ← nᵢ mods 4
        If nᵢ≡±3(mod8) and nᵢ₋₁≡2(mod4) then u ← −u
        Set uᵢⱼ ← u
      Next i
      Set j ← j+1
EndWhile
```

By contrast, the present invention provides a recoding method which is performed in a left-to-right order and which computes a signed-binary representation of several non-negative integers with a minimum joint weight.

The left-to-right order of the recoding and computation steps allows the recoding and computations to be combined into a single left-to-right set of operations, resulting in significant reductions in memory utilization. The invention provides optimization of joint weights comparable to the JSF method, while it is readily implemented and utilizes a left-to-right order more compatible with the computation of gP+hQ which reduces memory requirements. In addition, the combination of recoding and computation within the present invention allows the method to be fully or partially implemented in hardware.

The recoding of the present invention is based on the following observation which is commonly used in Booth multiplication of two's complement binary numbers.

Let d be an L-bit number (dL,atd₂,. .., dl, do₀). Then d can be written as d=d__ 2(L-1) +d_ 22(-2) ++d,2 +do. Since 2x =2x+-2x, we can express d as follows. d =(d/ l -0)2(L) +(d/_2 -d/_1)2(/-) +.+(d, -d₂)2² +(do -d,)2+(o-do) d can now be expressed as an (L+1) -bit number, X =((dL₁ -O),(dL₂ -d- ₁),...,(do-d₁),(O-do)) Each digit can be either 0, 1 or -1. Using the above observation we obtain our new recoding for g and h. Let g and h be two L-bit binary numbers expressed as follows. h =(hL-₁ hL-2... ho) ) Algorithm 1 below outlines an embodiment of the present method for computing the new binary signed-digit representation.

Algorithm 1. 1. Convert the binary representation of g and h into:

xl =((gL₁- 0),(gL-₂-g-₁) ...I(g₀ -g₁)(O -g₀)) X₂ =((h-l o)I(hL-2-h-l) ....(ho-/ ),(O-ho)). 2. Convert Xl and X₂ into Y, and Y2 by going from left to right and performing any of the following replacements only if it results in a decrease in the joint weight. replace 1, -1 by 0, 1;

replace -1, 1 by 0, -1;

replace 1, 0, -1 by 0, 1, 1;

replace -1, 0, 1 by 0, -1, -1;

replace 0, -1, -1 by -1, 0, 1;

replace 0, 1, 1 by 1, 0, -1.

FIG. 2 illustrates by way of example the recoding process associated with Algorithm 1. The generation of the binary signed-digit representation is depicted in block 30, the replacement of groups of binary digits is represented by block 32, and the particular replacement patterns according to one specific embodiment of the invention are given by block 34. The pseudo-code for executing Algorithm 1 is given below as Algorithm 2.

Algorithm 2.

```
Input: Binary representations of g and h.
        g=(g_{L-1},g_{L-2},...,g₁,g₀)
        h=(h_{L-1},h_{L-2},...,h₁,h₀)
Output: New binary signed-digit recoding of g and h given by U[i][j].
Set U[0][L] ← g_{L-1}−0,U[1][L] ← h_{L-1}−0
For j from L−1 to 0 do
    If j>0 then set U[0][j] ← g_{L-1}−g_{L},U[1][j] ← h_{L-1}−h_{L}
    Else set U[0][0] ← 0−g₀,U[1][0] ← 0−h₀
    For i from 0 to 1 do
      If U[i][j+1]×U[i][j]=−1 and
          (U[1−i][j+1]=0 or U[1−i][j+1]×U[1−i][j]=−1)
      Then set U[i][j+1] ← 0 and U[i][j] ← −U[i][j]
    Next i
    If j<L−1
      Then for i from 0 to 1 do
          If U[i][j+2]×U[i][j]=−1 and U[i][j+1]=0
            and U[1−i][j+2]=0 and U[1−i][j+1]≠0
            Then set U[i][j+2] ← 0, U[i][j+1] ← −U[i][j] and
                U[i][j] ← −U[i][j]
          Else if U[i][j+2]=0 and U[i][j+1]×U[i][j]=1
            and U[1−i][j+2]≠0 and U[1−i][j+1]=0
            Then set U[i][j+2] ← U[i][j], U[i][j+1] ← 0
                and U[i][j] ← −U[i][j]
          Else if U[i][j+2]×U[i][j]=−1 and U[i][j+1]=0
            and U[1−i][j+2]×U[1−i][j+1]=−1 and U[1−i][j]=0
            Then set U[i][j+1] ← U[i][j+2],
                U[i][j] ← U[i][j+2], U[i][j+2] ← 0,
                U[1−i][j+1] ← −U[1−i][j+1] and U[1−i][j+2] ← 0
      Next i
Next j
```

Note that in Algorithm 2 we scan g and h only once from left to right three bits at a time. Algorithm 2 can be combined with Shamirs method for computing gP+hQ thereby eliminating the necessity for storing Y, and Y2 as the outputs of Algorithm 1.

Therefore, considering the case in which g and h are 53 and 102, Step 1 in Algorithm 1 results in the following: XIl=0 1 0 -1 1 -1 1 -1 X2 =1 0-1 0 1 0 -1 0

The joint weight is now 8. Executing Step 2 results in the following: Y, 0 1 0 0-1 0-1-1 Y2- 0 1 1 0 1 0-1 0

After execution the joint weight is now five (5). Converting g and h to the joint sparse form (JSF) also achieves a joint weight of five (5). The JSF of g=53and h=102is 53 =0 1 0 0 -1 0 -1 -1 102=0 1 1 0 1 0-1 0

As described later, Algorithm 2 results in an average joint weight of L/2. This is known to be an optimal value according to the JSF. The simplicity of the inventive method as embodied herein can be appreciated by comparing the results from the invention with that produced according to the JSF method. An algorithm for computing g and h within the JSF model is detailed below. In the algorithm below the JSF of g and h is given by:

(uO,-₁ , UO,L₂ ,. , u o, uo,₀ ) and (uLn₁ 9 ula₂9... 9 , u_{14,}o ₎

The function “mods” indicate that the modular reduction is to return the smallest residue in terms of absolute value. The following theorem states the optimum nature of our method, although no proof is given due to space limitations. According to a first theorem of this method, the average joint weight among the signed binary representations of L -bits from Algorithm 2 is L12.

Comparing Methods.

To properly compare the method of the present invention with the JSF method, the algorithms associated with each of these two methods have been simulated with the results provided in Table 2. Each row of the table was obtained by randomly generating one million L -bit binary numbers, g and h, and computing the average joint weight from the JSF algorithm and from Algorithm 2, according to an embodiment of the present invention. The first column in Table 2 lists the number of bits (L ) found in g and h. The second and third column gives the joint weight and execution time obtained for the JSF algorithm. The fourth and fifth columns provide the joint weight and execution times obtained from Algorithm 2. The algorithms were executed on the same processing platform for these tests, by way of example a Pentium IV Mobile processor operating at 1.8 GHz. The last five rows in the table correspond to the size of field elements for the elliptic curves defined by the National Institute of Standards and Technology (NIST) as in the publication “Digital Signature Standard”, FIPS publication 186-2, Feb. 2000.

From Table 2 it can be seen that the joint weights obtained from the JSF algorithm and Algorithm 2 approximate L12. Therefore, we can conclude that the joint weight resulting from Algorithm 2 is optimal as shown in the technical report by J.A. Solinas, “Low-weight Binary Representations for Pairs of Integers”; Technical Report CORR 2001-41, Center for Applied Cryptographic Research, University of Waterloo, Canada, 2001. Since the method according to an embodiment of the present invention scans g and h from left-to-right, using only 3 signed-bits of memory for each integer, it can be considered superior to the JSF algorithm based process due to a substantially decreased memory requirement. Furthermore, the present invention can also be embodied in hardware, or in a combination of hardware and software, as a sequential circuit with the bits of g and h as input (the most significant bits are input first). Whereas the JSF algorithm is not readily amenable to implementation in a sequential logic circuit. Even when comparing both methods implemented in software, the present invention provides somewhat faster execution times that an implementation of the JSF based approach (referring to columns 4 and 5 of Table 2).

The present invention provides a method of obtaining a signed binary representation of two integers that results in optimal joint weight. The algorithm on which the method is based has a lower complexity than the best known algorithm, namely the JSF algorithm. One of the major advantages of the method and algorithm of the present invention, is that it scans from left-to-right, using only three signed-bits of memory for each integer, thus making it compatible with Shamir's method for computing gP+hQ . The method according to the present invention can be readily extended to find the signed binary representations of more than two integers.

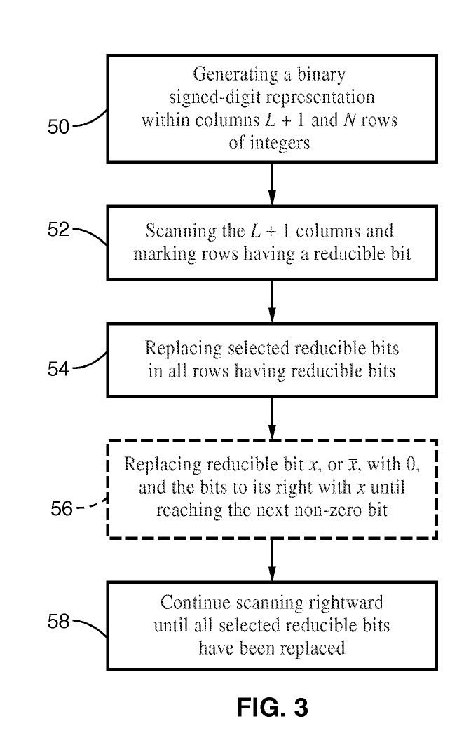

FIG. 3 illustrates by way of example the general recoding process being performed for any number of non-negative integers. The non-negative integers, represented as N non-negative integers ki. For the case of N integers the present invention requires just (N+1) signed-binary bits of memory. The binary representations of the N integers within N rows comprise L traditional binary columns which are converted into L +1 columns of binary-signed digits. The binary signed representation is generated at block 50. The signed bit columns of each of the N integer rows is then marked if it has a reducible bit as per block 52. Selected reducible bits are replaced as depicted in block 54, the replacement being preferably performed as per block 56 by replacing non-zero (x or Y) bits with zero and the bits to the right with x until reaching the next non-zero bit. In block 58 the left-to-right scanning continues until all reducible bits have been replaced.

The process of determining a signed-binary representation of any number of non-negative integers is outlined in greater detail as Algorithm 3.

Algorithm 3.

Step 1: Convert the binary representation of each ki (O<i <N-1) into an (L+1) -bits {0,1,-1} -based representation using the following rule:

ki=((i,L-1 - 0)I (i,L-1 -ki,L-1)..-I(ki,O -ki,l)(°-ki,O Step 2: Scan all the (L +1) columns in the array from the left-most column to the right-most column (0). Note that there are N entries in each column. Step 3a: If all the N entries in the column being scanned is non-zero, then perform Step 4. Step 4: Mark the rows, which have a non-zero bit in the column being scanned. The non-zero bit is called a “reducible bit”. Step 5: Scan the marked rows from the reducible bit and go rightwards, looking at N bits at the most. Step 6a: If the rightward non-zero bit for at least one marked row is not within the next N bits, such as the next N bits to the right of the reducible bit being all zero, then skip that column and continue to scan the next column to its right. Step 6b: If the next rightward non-zero bit for all marked rows is within the next N bits, then among all marked rows let the maximum distance between the reducible bit and the next rightward non-zero bit be (C-1), for example wherein there are (C-1) zeros between the reducible bit and next rightward non-zero bit. Continue to Step 7. Step 7: Scan the columns from the column with the farthest non-zero bit found in Step 6b to the column with reducible bits. Note that unlike the scanning that this is a right-to-left sweep of (C+1) bits. Step 8: Determine if there exists at least one non-zero entry in each of the (C +1) columns being scanned in Step 7. Note that except for the left-most column within the Nx(C+l) table, at least one of the non-zero values for every non-zero column must be the right-most in that row. Step 9a: If at least one column among the (C +1) columns is zero, then skip that column and continue to scan the next column to its right.

Step 9b: If all the (C+1) columns are non-zero and satisfy the condition of Step 8, then perform Step 10.

Step 10: Suppose the reducible bit in one marked row is x (xe {E,- ).

First replace x by 0. Then replace the bits to its right by x. The second replacement is performed until the next non-zero bit x-. Note that x is also replaced by x, for example replacing xO . . Ox- with Ox ... xx.

Step 11: Skip columns and continue to scan backwards until arriving at the right-most column. Note that the C columns are the columns that have already been replaced.

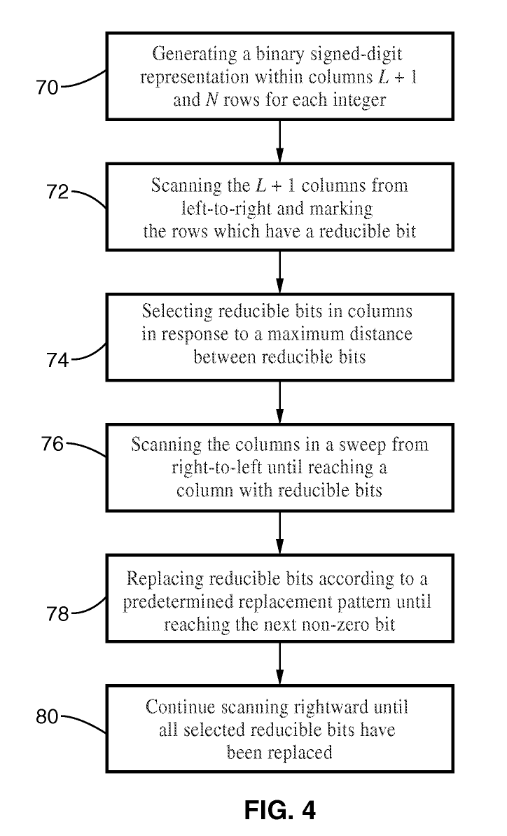

FIG. 4 illustrates some of the detailed aspects of Algorithm 3. The signed binary representation is generated at block 70 and the rows are marked in response to scanning the columns from left-to-right for reducible bits as shown in block 72. Reducible bits are selected in response to distance between bits in block 74 and a right-to-left scan is performed until a column with reducible bits is found as per block 76. The selected reducible bits are replaced according to a predetermined replacement pattern as per block 78 performed in a left-to-right scan. The scanning in the left-to-right direction is then continued as given by block 80 until all reducible bits have been replaced.

Algorithm 3 can be described in greater detail as recited in the following description and pseudo-code listing. Algorithm 3 generally consists of two steps:

Step 1: Converting the unsigned-binary input to the alternating greedy expansions.

Step 2: Making replacements on the alternating greedy expansions.

In Step 2, three conditions must be satisfied before a replacement takes place. These three conditions are:

C1: LeftmostIsNonzero # 0.

C2: For each kELeftmostIsNonzero there is an i with j >i >EndComputingAlternatingGreedy satisfying (k) o .

C3: { i: j >i >MinNextNonzeroLocation } ={ RightmostNonzeroLocation [k]: 1 <k <d }

If all three conditions are satisfied then the leftmost column of the d +I columns being scanned will be converted from nonzero to zero. The policy is to replace xO...Ox- with Ox...xx (xE {-1,11) in each row k with kE LeftmostIsNonzero. The algorithm then skips the columns involved in the replacement and restarts the scanning.

If one or more of the three conditions are not satisfied,then Algorithm 3 moves rightward by one column and restarts the scanning.

The properties of Algorithm 3 are stated in the following lemmas and theorems.

Theorem 1. The output of the algorithm has minimal joint Hamming weight among any signed-binary expansions of the d given integers.

Theorem 2. Let J >d be the index of a column such that we have j =J at some stage of the algorithm. Then at least one of the columns J....,J-d will be a zero column in the output of the algorithm.

Theorem 3. Among 2d +1 consecutive columns of the algorithm output, there is at least one 0.

When implemented in hardware the algorithm leads to a significant reduction in hardware overhead. This is because the binary input 7k) is never used again after the calculation of (k) Therefore, the input array ) and the output array _k) can share the same memory space.

During the computation, the number of active columns (i.e. columns that are being scanned) is at most d +1. If the output of the algorithm is input to a real-time processor for further operation, then the amount of required memory could be reduced to as low as d x(d +1) signed-binary bits.

The pseudo-code for the above algorithm follows:

Algorithm 3 pseudo code example for computing a minimal joint expansion from the unsigned binary expansion from left to right.

```
Input: ηⱼ^{(k)} where 1≦k≦d and 0≦j≦J−1 unsigned-binary expansion of
      the integers x⁽¹⁾,...,x^{(d)}
Output: εⱼ^{(k)} where 1≦k≦d and 0≦j≦J signed-binary expansion of
      x⁽¹⁾,...,x^{(d)} with minimum joint Hamming weight.
η_{J}^{(k)} ← 0 for each k with 1≦k≦d
η₋₁^{(k)} ← 0 for each k with 1≦k≦d
StartComputingAlternatingGreedy ← J
j ← J
while j≧0 and StartComputingAlternatingGreedy ≧0 do
    EndComputingAlternatingGreedy ← max(j−d,0)
    for 1≦k≦d do
      for StartComputingAlternatingGreedy ≧i≧
    EndComputingAlternatingGreedy do
          εⱼ^{(k)}=ηᵢ₋₁^{(k)}−ηᵢ^{(k)}
      end for
    end for
    StartComputingAlternatingGreedy
          ← EndComputingAlternatingGreedy − 1
    LeftmostIsNonzero ← {1≦k≦d:εⱼ^{(k)}≠0}
    if C1 and C2 are satisfied then
      NextNonzeroLocation[k] ← max{i:j>1 and εᵢ^{(k)}≠0} for each
            kεLeftmostIsNonzero
      MinNextNonzeroLocation ← min {NextNonzeroLocation[k]:kε
            LeftmostIsNonzero}
      RightmostNonzeroLocation[k] ← min{ j>i≧
            MinNextNonZeroLocation : εᵢ^{(k)}≠0 }
      for 1≦k≦d and εᵢ^{(k)}≠0 for some j>i≧ MinNextNonzeroLocation
      BitsAllZero ← {1≦k≦d:εᵢ^{(k)}=0 for all j>i≧
            MinNextNonzeroLocation }
      if C3 is satisfied then
          for all kεLeftmostIsNonzero do
            εᵢ^{(k)} ← εⱼ^{(k)} for each i with j−1≧i≧
            NextNonzeroLocation[k]
            εⱼ^{(k)} ← 0
          end for
          j ← MinNextNonzeroLocation − 1
      else
          j ← j−1
      end if
    else
      j ← j−1
    end if
end while
```

For the case of a single integer, Algorithm 3 reduces to that of Algorithm 4.

Algorithm 4.

Let k be an L -bit unsigned binary number:

k =(kLlkL2 _{...}kₗkₒ) Step 1: Convert the unsigned binary expansion n into:

k =((kL-l -) (kL-2 - k-)......(k.-kl)(-ko)) Step 2: Make replacements on the alternating greedy expansion of k by going from left to right and replacing xx by Ox, where xE I1,-II . The left-to-right scanning is preferably executed bit-by-bit. However, if a replacement is applied, then the replaced bits are skipped and the scan continues rightwards.

Consider the following example.

Letting k=155. Its unsigned binary expansion is (010011011), with a Hamming weight of five (5). Step 1 of this algorithm results in the binary expansion (ioio0io). Step 2 outputs (o0o1oo1o1) wherein the Hamming weight is thus reduced to four (4).

For the case of two integers a and b. Algorithm 3 reduces to Algorithm 5.

Algorithm 5.

Step 1: Convert unsigned binary expansion of a and b into P, and P2:

p=((aL- -O),(aL-₂ -a₁, ₁)........ ,(ao -a,),(O-a₀)) P2 =((bhL-o),(bL-₂-bh₁ )I ....... ,(bo-bl),(O-bo))

Step 2: Convert P, and P2 into Q, and Q₂ by going from left to right and executing any the following replacements which are applicable. In the replacements shown below the top row of digits belongs to P, and the bottom row of digits belongs to P2 while x,yE II,-II . If a replacement is applied then the columns are discarded which have been replaced and the next two or three columns considered for replacement. If no replacement is possible then discard one column and consider the next two or three columns for replacement.

$$A 1. [ \begin{matrix}0 & x \\ y & \overline{y}\end{matrix} ] \to [ \begin{matrix}0 & x \\ 0 & y\end{matrix} ] OR [ \begin{matrix}0 & 0 \\ y & \overline{y}\end{matrix} ] \to [ \begin{matrix}0 & 0 \\ 0 & y\end{matrix} ]$$

$$A 2. [ \begin{matrix}x & \overline{x} \\ y & \overline{y}\end{matrix} ] \to [ \begin{matrix}0 & x \\ 0 & y\end{matrix} ]$$

$$A 3. [ \begin{matrix}x & 0 & \overline{x} \\ 0 & y & 0\end{matrix} ] \to [ \begin{matrix}0 & x & x \\ 0 & y & 0\end{matrix} ]$$

$$A 4. [ \begin{matrix}x & 0 & \overline{x} \\ y & \overline{y} & 0\end{matrix} ] \to [ \begin{matrix}0 & x & x \\ 0 & y & 0\end{matrix} ]$$

Note that if x =1 then x- =-1

$$[ \begin{matrix}{c}_{1} & {c}_{2} & {c}_{3} \\ {d}_{1} & {d}_{2} & {d}_{3}\end{matrix} ] \to [ \begin{matrix}{e}_{1} & {e}_{2} & {e}_{3} \\ {f}_{1} & {f}_{2} & {f}_{3}\end{matrix} ]$$

It should also be noted that if is a replacement then so is

$$[ \begin{matrix}{d}_{1} & {d}_{2} & {d}_{3} \\ {c}_{1} & {c}_{2} & {c}_{3}\end{matrix} ] \to [ \begin{matrix}{f}_{1} & {f}_{2} & {f}_{3} \\ {e}_{1} & {e}_{2} & {e}_{3}\end{matrix} ] .$$

This is because it is inconsequential whether we write P, on the top or P₂.

Consider the following example having two integers a and b.

Suppose that a =6699 and b=4846. The binary expansion of a and b is given by:

$$[ \begin{matrix}a \\ b\end{matrix} ] \to [ \begin{matrix}1 & 1 & 0 & 1 & 0 & 0 & 0 & 1 & 0 & 1 & 0 & 1 & 1 \\ 1 & 0 & 0 & 1 & 0 & 1 & 1 & 1 & 0 & 1 & 1 & 1 & 0\end{matrix} ]$$

The joint weight of the above is ten (10). Applying Step 1 of Algorithm 5 (two integer case) we arrive at:

$$[ \begin{matrix}{P}_{1} \\ {P}_{2}\end{matrix} ] \to [ \begin{matrix}1 & 0 & \overline{1} & 1 & \overline{1} & 0 & 0 & 1 & \overline{1} & 1 & \overline{1} & 1 & 0 & 1 \\ 1 & \overline{1} & 0 & 1 & \overline{1} & 1 & 0 & 0 & \overline{1} & 1 & 0 & 0 & \overline{1} & 0\end{matrix} ]$$

The result of step 1 has a joint weight of nine (9).

$$[ \begin{matrix}{Q}_{1} \\ {Q}_{2}\end{matrix} ] \to [ \begin{matrix}0 & 1 & 1 & 0 & 1 & 0 & 0 & 0 & 1 & 1 & 0 & \overline{1} & 0 & \overline{1} \\ 0 & 1 & 0 & 0 & 1 & 1 & 0 & 0 & \overline{1} & 1 & 0 & 0 & \overline{1} & 0\end{matrix} ]$$

$$[ \begin{matrix}{P}_{1} \\ {P}_{2}\end{matrix} ]$$

The left-most three columns of have been replaced using replacement A3, the two columns after that have used replacement A2 and so on.

Finally we discuss a more complicated case. The number of integers N is three (3). Considering the case where k, =23, k₂=15 and k₃ =7, the binary expansion is given by:

$$[ \begin{matrix}23 \\ 15 \\ 7\end{matrix} ] = [ \begin{matrix}0 & 1 & 0 & 1 & 1 & 1 \\ 0 & 0 & 1 & 1 & 1 & 1 \\ 0 & 0 & 0 & 1 & 1 & 1\end{matrix} ]$$

Step 1 of Algorithm 3 results in:

$$[ \begin{matrix}23 \\ 15 \\ 7\end{matrix} ] = [ \begin{matrix}1 & \overline{1} & 1 & 0 & 0 & \overline{1} \\ 0 & 1 & 0 & 0 & 0 & \overline{1} \\ 0 & 0 & 1 & 0 & 0 & \overline{1}\end{matrix} ]$$

Step 2 suggests starting with the left-most column, [1 0 O]T. As this is a non-zero column we move to Step 4. The first row is marked and the “1” in the first row is a reducible bit. Step 5 asks us to look rightwards with a distance of not more than N, which in this case is three (3), in looking for the next non-zero bit. We have found the bit immediately to the right of the 1 is T (-1). Here we have C =1 in Step 6b. When we do the left-to-right scanning in Step 7, we find that the condition in Step 8 is satisfied. Now we perform Step 10 and replace 11 of the first column by 01 .

$$[ \begin{matrix}23 \\ 15 \\ 7\end{matrix} ] = [ \begin{matrix}0 & 1 & 1 & 0 & 0 & \overline{1} \\ 0 & 1 & 0 & 0 & 0 & \overline{1} \\ 0 & 0 & 1 & 0 & 0 & \overline{1}\end{matrix} ]$$

According to Step 11, we discard the left-most two columns. Now we look at the third column from the left, which is a non-zero column [1 0 ₁]T. The first and third columns are marked. A rightward scan is performed to find the next rightward non-zero bits of the first and third row (the first and third -ls at the right-most column of the array), herein being C =3. Step 8 asks us to determine if there exists at least one non-zero entry in each of the (C+1) columns. Unfortunately this is not true since there are two zero columns between the column [1 0 ₁]T and [-1 -1 _₁]T. So we do nothing to the column being scanned, which in this case is the third column from the left. Then we move to the fourth column, which in this case is a zero column. According to Step 3b we discard this column and move rightwards again. The fifth column of this example has the same situation. The right-most column does not need to be scanned because it is impossible for it to be reduced. Wherein we arrive at the final output, which is given by:

$$[ \begin{matrix}23 \\ 15 \\ 7\end{matrix} ] = [ \begin{matrix}0 & 1 & 1 & 0 & 0 & \overline{1} \\ 0 & 1 & 0 & 0 & 0 & \overline{1} \\ 0 & 0 & 1 & 0 & 0 & \overline{1}\end{matrix} ]$$

The joint weight is three (3), which is the minimum possible joint weight among all signed-binary combinations of the integers 23, 15 and 7.

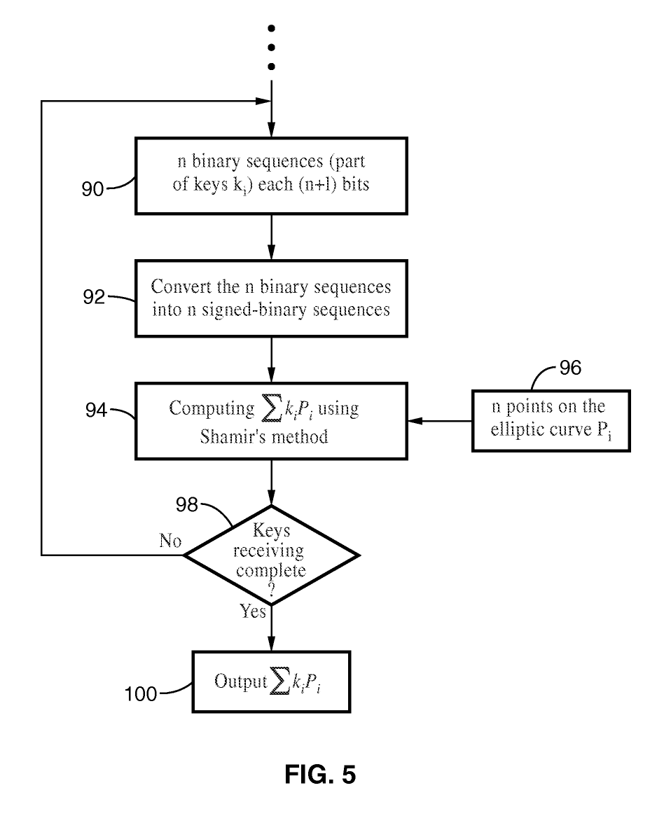

FIG. 5 illustrates performing the recoding within software. A program executes an reaches the recoding sequence, wherein N binary sequences are received as represented by block 90. The input sequence is converted into an n bit signed-binary representation at block 92. The computation E kBP is performed, preferably using Shamirs method, as per block 94 with n points on the elliptic curve Pi as from block 96. If reception of the keys is not complete, as determined at block 98 then the sequence processing continues at block 90. The sequence is completed at block 100 when the computation of I kiP is output.

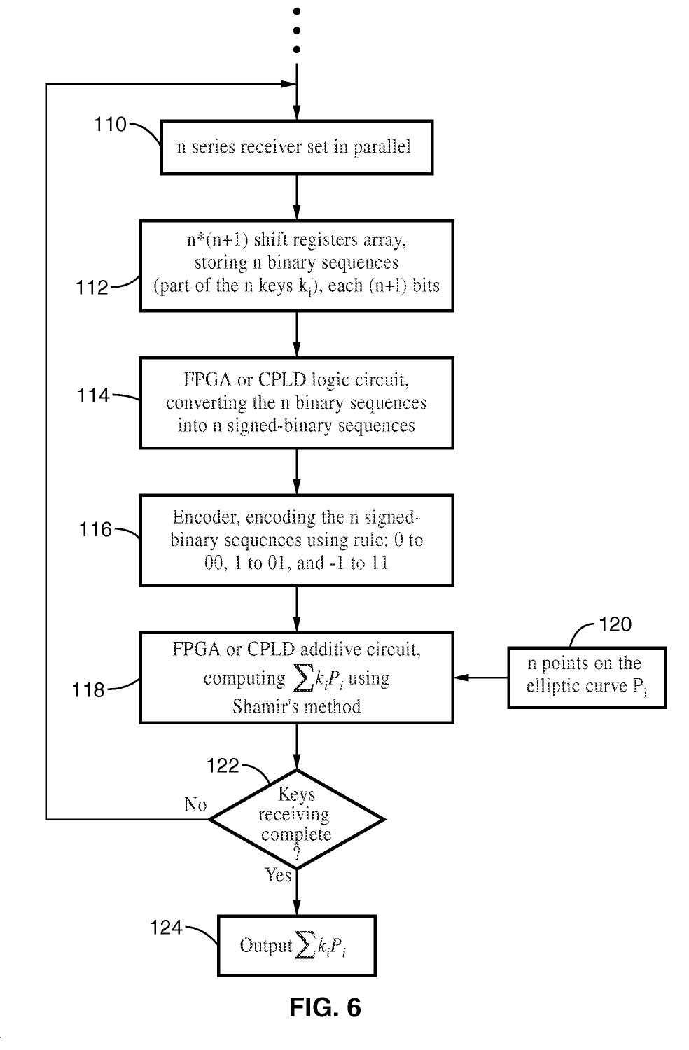

FIG. 6 illustrates performing the recoding within hardware. An n series receiver set in parallel executes in block 110 and shift registers store sequences in block 112 in preparation for conversion to signed-binary sequences in block 114 which are then encoded in block 116. A computation is then performed of I kiP in block 118 based on points from the elliptic curve represented by block 120. If all the keys have been received, as determined by block 122, then output is generated at block 124, otherwise the processing continues at block 110.

In order to understand an embodiment of the hardware the relationships between the input, intermediate, and signed-binary representation are discussed and an algorithm presented.

Table 3 presents the relationship among the binary input, the intermediate signed-binary representation (ISBR) and the optimal signed binary output sequence. Two bits of output can be determined once three bits of input are received. For three consecutive bits of input (bi,bi1 -,bi₂) the notation ISBR(bi,bi-,,b,-₂) denotes the corresponding bits of the alternating greedy expansion (ai,ai-₁) and OUT(b,,bi-,,bi-₂) to denote the corresponding output bits of the optimal signed binary representation (s,si l). The algorithm below presents how this operates in hardware.

### Algorithm 6.

```
Input: L-bit binary expansion (b_{L-1},b_{L-2},...,b₁,b₀) of a non negative integer
k.
Output: Signed binary representation (s_{L-1},s_{L-2},...,s₁,s₀) of k such that the
weight is minimum.
b_{L} ← 0; b₋₁ ← 0; i ← L;
(sᵢ,sᵢ₋₁) ← OUT(bᵢ,bᵢ₋₁,bᵢ₋₂)
while i≧2 do
    i ← i−1
    (aᵢ,aᵢ₋₁) ← ISBR(bᵢ,bᵢ₋₁,bᵢ₋₂)
      If aᵢ=sᵢ then
          (sᵢ,sᵢ₋₁) ← OUT(bᵢ,bᵢ₋₁,bᵢ₋₂)
    else
      sᵢ₋₁ ← aᵢ₋₁
    end if
end while
```

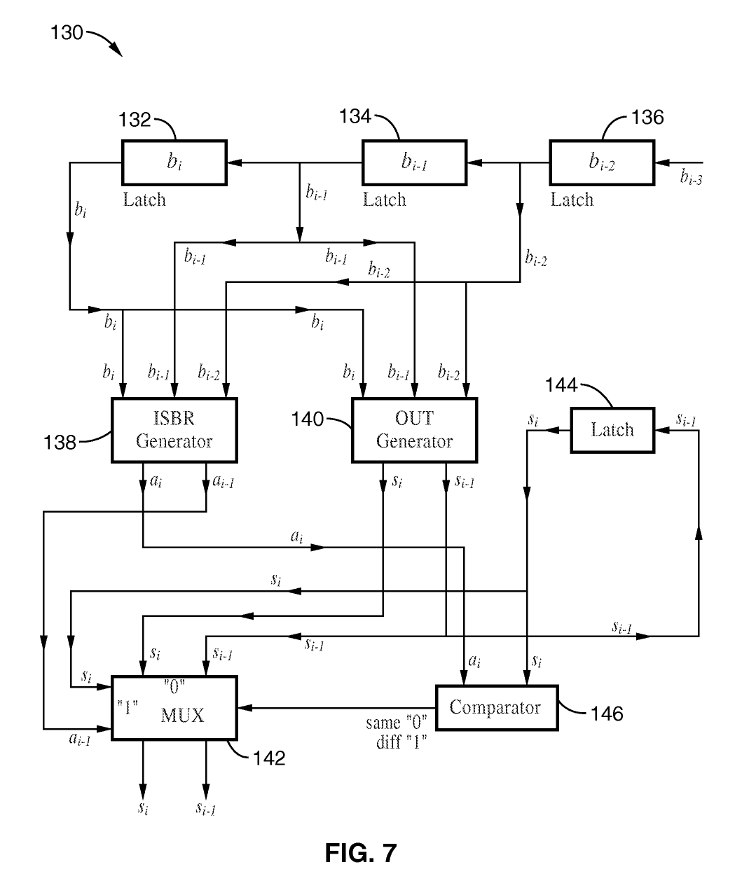

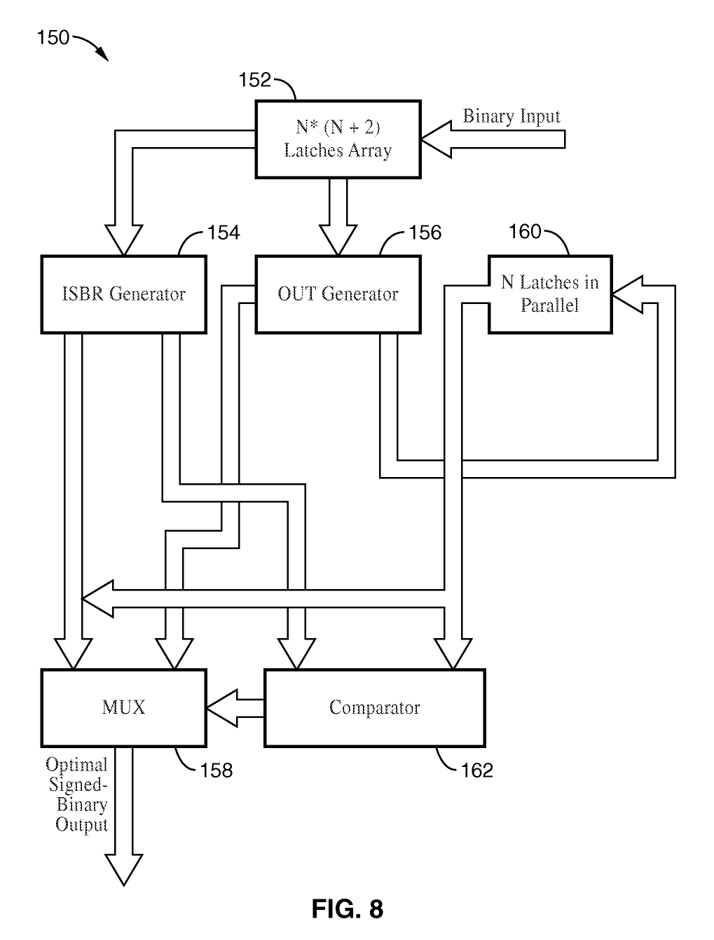

FIG. 7 and FIG. 8 depict embodiments 130, 150 of signed-digit recoding apparatus according with the invention. FIG. 7 depicts a hardware implementation 130 for one integer. As was described for Algorithm 6, once three binary bits are input then two signed-binary bits output can be determined. The output is based on the current and previous input. The three latches 132, 134, 136 on the upper row form a latching means which receives the input bits (bi,bi -,bi-₂), preferably one by one as a shift procedure.

A means for generating a signed-binary intermediate (ISBR) representation can be implemented as a logic circuit or gate array, or similar, configured for converting a received unsigned binary bit pattern into a signed-binary bit pattern. This generating means receives bits (bi,bi-,,bi-2) as input and is referred to as ISBR generator 138. A means for generating a signed-binary output (OUT) representation can be similarly implemented as a logic circuit or gate array, and so forth, configured for converting a received unsigned binary bit pattern into a signed-binary bit pattern. This generating means also receives bits (bi,bi-,,bi-2) as input and is referred to as OUT generator 140.

The output of ISBR generator 138 and OUT generator 140 follows according to the lookup table (Table 3). Let the output of ISBR generator 138 be (aiai-₁) and that of OUT generator 140 be (sj,sil). Then the final output could be either (sj,sil) or (siI,ai-l), depending on if ai and si are equal or not. A means for selecting either ISBR bits or OUT bits is shown comprising a multiplexer such as MUX 142 which is used as a “switch” to control which bits to be output. The control signal should be “0” if ai =Si-I and “1” otherwise.

Since at and S1.- are not with the same index, they cannot be compared directly. A means for comparing ISBR bits to previous OUT bits is needed for controlling the signal selection means. The OUT signal can be delayed, such as by using a latch, to allow a proper comparison between ISBR and OUT signals, wherein latch 144 is utilized to delay S._I for one clock cycle. Thus S. 1 becomes si The comparison between at and Si is performed by a comparator 146, which generates a “0” to MUX 142 if ai =Si-₁, and “1” otherwise. [00109] FIG. 8 is a block diagram of the conversion hardware utilized for converting N integers. It should be appreciated that the lookup table is responsive to the value of N utilized. The conversion hardware 150 RFT-126-3US 31 comprises latching array 152, ISBR generator 154, OUT generator 156, MUX 158, parallel patches 160 and comparator 162. The function of blocks in FIG. 8 comports to the blocks in FIG. 7, for example the array of latches 152 in FIG. 8 illustrates the function as shown by the three latch devices 132, 134 and 136 within FIG. 7. [00110] The present invention provides optimal recoding methods which can significantly reduce the memory overhead to which elliptic curve cryptography systems are currently subject. The method also makes the ECC processing amenable to being performed in hardware, or any desired mix of hardware and firmware/software. It will be appreciated that a number of examples were provided with regard to specific integer instances and relationships between the integers, however, these were provided by example only and the methods and/or hardware can be executed for any number of integers. The method and/or hardware can be performed in response to a number of algorithms, examples of which have been described. It should, however, be appreciated that one of ordinary skill in the art can extend or otherwise modify these algorithms in a number of ways without departing from the teachings of the present invention. [00111] Although the description above contains many details, these should not be construed as limiting the scope of the invention but as merely providing illustrations of some of the presently preferred embodiments of this invention.

Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each RFT-126-3US 32 and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Computation of gP + hQ Using Shamir Method

| | | | | | | | | |
|---|---|---|---|---|---|---|---|---|
| g | 0 | 1 | 0 | 0 | −1 | 0 | −1 | −1 |
| h | 0 | 1 | 1 | 0 | 1 | 0 | −1 | 0 |
| Double | | 1 | 2P + 2Q | 4P + 6Q | 8P + 12Q | 14P + 26Q | 28P + 52Q | 54P + 102Q |
| P | | | | | | | | |
| Q | | | 2P + 3Q | | | | | |
| −P + Q | | | | | 7P + 13Q | | | 53P + 102Q |
| P + Q | | P + Q | | | | | | |
| −(P + Q) | | | | | | | 27P + 51Q | |

TABLE 2
Comparison of JSF Algorithm and Algorithm 2

| | JSF Algorithm | | Algorithm 2 | |
|---|---|---|---|---|
| L | Joint Weight | Time (Seconds) | Joint Weight | Time (Seconds) |
| 80 | 42.3 | 17.9 | 40.8 | 15.5 |
| 120 | 63.5 | 27.3 | 60.6 | 21.7 |
| 250 | 131.7 | 52.9 | 125.5 | 44.5 |
| 350 | 182.5 | 72.4 | 175.6 | 60.5 |
| 450 | 235.7 | 92.6 | 225.5 | 76.5 |
| 163 | 86.2 | 34.9 | 82.1 | 29.4 |
| 233 | 122.1 | 50.0 | 116.2 | 40.6 |
| 283 | 148.7 | 58.9 | 142.0 | 49.9 |
| 409 | 214.5 | 83.2 | 205.0 | 70.8 |
| 571 | 298.9 | 114.8 | 285.9 | 96.1 |

TABLE 3
Binary Input, Intermediate and Output Sequences

| Binary | | Signed-B |
|---|---|---|
| Input | ISBR | Out |
| (bᵢ, bᵢ₋₁, bᵢ₋₂) | (aᵢ, aᵢ₋₁) | (Sᵢ, Sᵢ₋₁) |
| 000 | 00 | 00 |
| 001 | 01 | 01 |
| 010 | 1 1̅ | 01 |
| 011 | 10 | 10 |
| 100 | 1̅0 | 1̅0 |
| 101 | 1̅1 | 0 1̅ |
| 110 | 0 1̅ | 0 1̅ |
| 111 | 00 | 00 |

What is claimed is:

1. An apparatus for recoding non-negative integers to reduce joint weight associated with a scalar multiplication, comprising:
means for latching at least three binary bits received as integer input;
means for generating a signed-binary intermediate (ISBR) representation in response to receiving binary bits from said means for latching;
means for generating a signed-binary output (OUT) representation in response to receiving binary bits from said means for latching;
means for comparing the ISBR bits with previous OUT bits; and
means for selecting either ISBR bits or OUT bits as integer output in response to the comparison performed by said means for comparing;
whereby a reduced joint weight of the integer output from the selecting means reduces scalar multiplication overhead.

2. An apparatus as recited in claim 1:
wherein signed-binary digits are represented with 0, 1 and -1 (T) instead of a binary representation with 0 and 1; and
wherein joint weight is determined by the number of non-zero columns in said integer output.

3. An apparatus as recited in claim 1, wherein resultant joint weight reduction is equivalent to that produced using joint sparse form (JSF) techniques.

4. An apparatus as recited in claim 1:
wherein said means for latching comprises an array of latches;
wherein said means for generating a signed-binary intermediate (ISBR) representation comprises a logic circuit or gate array configured for converting a received unsigned binary bit pattern into a signed-binary bit pattern;
wherein said means for generating a signed-binary output (OUT) representation comprises a logic circuit or gate array configured for converting a received unsigned binary bit pattern into a signed-binary bit pattern;
wherein said means for comparing the ISBR bits with previous OUT bits comprises a latch configured for delaying the bits being output from said OUT generator, and a comparator; and
wherein said means for selecting either ISBR bits or OUT bits comprises a multiplexer configured for outputting a digital output as selected by a control signal from either of two digital signals being received.

5. An apparatus for recoding non-negative integers to reduce joint weight associated with a scalar multiplication, comprising:
an array of latches configured for receiving at least three binary bits received as integer input;
an intermediate signed-binary representation (ISBR) generator configured for generating signed-binary intermediate values in response to receiving binary bits from said array of latches;
an output (OUT) generator configured for generating signed-binary output values in response to receiving binary bits from said array of latches;
a comparison circuit configured for generating a control signal in response to comparing bits generated from said ISBR generator with bits previously generated by said OUT generator; and
a multiplexer having inputs coupled to the output of said ISBR generator and said OUT generator and configured for outputting bits from the selected source in response to said control signal from said comparison circuit;
whereby a reduced joint weight of the integer output from said multiplexer reduces scalar multiplication overhead.

6. An apparatus as recited in claim 5, wherein resultant joint weight reduction is equivalent to that produced using joint sparse form (JSF) techniques.

7. An apparatus as recited in claim 5, wherein said array of latches is configured to receive bits as a serial stream and provide parallel outputs.

8. An apparatus as recited in claim 5, wherein said intermediate signed- binary representation (ISBR) generator and said OUT generator are configured to perform a most significant bit to a least significant bit replacement of reducible bits in producing a signed-binary output.

9. An apparatus as recited in claim 5:
wherein said apparatus is configured for recoding three bits of input into two bits of signed binary output;
wherein said intermediate signed-binary representation (ISBR) generator converts binary digits according to any or all of the following replacement patterns:
replacing 000 with 00, replacing 001 with 01, replacing 010 with IT, replacing 011 with 10, replacing 100 with 10, replacing 101 with 11, replacing 110 with 0 1 , replacing 111 with 00; and
wherein said output generator converts binary digits received from said array of latches to an output according to any or all of the following replacement patterns:
replacing 000 with 00, replacing 001 with 01, replacing 010 with 01, replacing 011 with 10, replacing 100 with To, replacing 101 with 0 1, replacing 110 with o0, replacing 111 with 00.

10. A method of recoding non-negative integers to reduce joint weight associated with a scalar multiplication, comprising:
generating a binary signed-digit representation of at least two non-negative integers; and
replacing groups of binary signed-digits having reducible bits in response to scanning the binary signed digits from a most significant bit to a least significant bit to reduce the joint weight;
whereby reducing joint weight reduces scalar multiplication overhead.

11. A method as recited in claim 10:
further comprising performing scalar multiplication following said recoding; and
wherein said scalar multiplication is performed as part of executing elliptic curve cryptography (ECC).

12. A method as recited in claim 11, wherein said scalar multiplication is given by
$${\sum }_{i = 0}^{N - 1} {k}_{i} {P}_{i}$$
in wnicn ki are integers and g. are points along the elliptic curve.

13. A method as recited in claim 10, wherein the most significant bit to a least significant bit replacement of reducible bits is performed in combination with the most significant bit to a least significant bit scalar multiplication of said integers as each integer is scanned.

14. A method as recited in claim 10, wherein said groups of binary signed- digits being replaced is selected from the group of replacement patterns consisting of:
replacing 11 with 01, replacing 11 with 0-1, replacing 101 with 011, replacing 101 with OTT, replacing o I I with 101, and replacing 011 with 101.

15. A method as recited in claim 10, wherein said recoding is applied to two or more non-negative integers.

16. A method as recited in claim 15, wherein said replacing of reducible bits is performed in response to scanning the columns and marking rows with reducible bits and replacing the reducible bits.

17. A method as recited in claim 16, wherein said replacing of reducible bits comprises replacing reducible bit x, or x-, with 0, and the bits to its right with x until reaching the next non-zero bit.

18. A method as recited in claim 17, wherein said replacing is performed in response to an allowable maximum distance between the reducible bit and the next rightward reducible bit.

19. A method as recited in claim 10, wherein said generation of binary signed-digit representation comprises a Booth multiplication technique for two's complement binary numbers.

20. A method of performing a scalar multiplication in combination with a reduction in joint weight from recoding two or more non-negative integers, comprising:
(a) generating a signed binary representation of each integer ki from an L -bit conventional binary representation, wherein (O<i<N-1), into an (L+1) -bits {0,1,-1} -based representation according to ki =((ki,L-1 - 0) I (ki,L-₂ - ki,L-l),...L (kiro - kil ),( °-kiro));
(b) scanning the (L +1) columns in the array from the left-most column to the right-most column (0), wherein each column has N entries;
(c) marking rows which have a non-zero bit, reducible bit, in the column being scanned if all the N entries in the column being scanned are non-zero;
(d) scanning the marked rows from the reducible bit rightwards, scanning N bits at the most;
(e) skipping a column and continuing to scan the next column to its right if the rightward non-zero bit for at least one marked row is not within the next N bits;
(f) establishing a maximum distance between the reducible bit and the next rightward non-zero bit at (C-1) if the next rightward non-zero bit for all marked rows is within the next N bits among all marked rows;
(g) scanning columns in a right-to-left sweep of (c+1) bits from the column with the farthest non-zero bit found in Step (f) to the column with reducible bits;
(h) skipping a column and continuing to scan the next column to its right if at least one column among the (C+1) columns is zero;
(i) replacing bits if all the (C+1) columns are non-zero and there exists at least one non-zero entry in each of the (C+1) columns being scanned;
wherein said replacing comprises replacing x by 0, supposing that the reducible bit in one marked row is xe {1,-1}, followed by replacing rightward bits by x until the next non-zero bit x which is also replaced by x;
k) skipping columns and continuing to scan backwards until arriving at the right-most column, wherein the C columns are the columns that have already been replaced; and
(k) performing a scalar multiplication given by
$${\sum }_{i = 0}^{N - 1} {k}_{i} {P}_{i}$$
in which ki are integers and g. are points along a curve;
wherein said scalar multiplication is performed in combination with recoding of the integers, based on said replacing of bits, which reduces the joint weight of the integers.

21. A method of recoding non-negative integers to reduce joint weight for performing scalar multiplication, comprising:
(a) generating a signed binary representation of each integer ki, wherein (O<i <N-i), into an (L +1)-bits {0,1,-1} -based representation according to ki =((ki,L-1 - 0) I (ki,L-₂ - ki,L-1 ) L L (ki,o - kil ), (° - ki,o ));
(b) scanning the (L +1) columns in the array from the left-most column to the right-most column (0), wherein each column has N entries;
(c) marking rows which have a non-zero bit, reducible bit, in the column being scanned if all the N entries in the column being scanned are non-zero;
(d) scanning the marked rows from the reducible bit rightwards, scanning N bits at the most;
(e) skipping a column and continuing to scan the next column to its right if the rightward non-zero bit for at least one marked row is not within the next N bits;
(f) establishing a maximum distance between the reducible bit and the next rightward non-zero bit at (C-1) if the next rightward non-zero bit for all marked rows is within the next N bits among all marked rows;
(g) scanning columns in a right-to-left sweep of (c+1) bits from the column with the farthest non-zero bit found in Step (f) to the column with reducible bits;
(h) skipping a column and continuing to scan the next column to its right if at least one column among the (C+1) columns is zero;
(i) replacing bits if all the (C+1) columns are non-zero and there exists at least one non-zero entry in each of the (C+I) columns being scanned;
wherein said replacing comprises replacing x by 0, supposing that the reducible bit in one marked row is xe {i,-1}, followed by replacing rightward bits by x until the next non-zero bit x which is also replaced by x; and
k) skipping columns and continuing to scan backwards until arriving at the right-most column, wherein the C columns are the columns that have already been replaced;
(k) whereby recoding of binary signed-digits reduces joint weight and the overhead associated with performing a scalar multiplication.

22. A method of performing scalar multiplication within a public-key cryptosystem, comprising:
(a) generating a binary signed-digit representation of at least two non- negative integers k,;
(b) recoding the binary signed-digit representation in response to scanning integers from a most significant bit to a least significant bit (left-to-right); and
(c) sequentially performing a scalar multiplication of said integers k, along a curve as each integer is scanned from most significant bit to least significant bit (left-to-right);
$${\sum }_{i = 0}^{N - 1} {k}_{i} {P}_{i}$$
(d) wherein the scalar multiplication is given by in which k, are said integers and 8. are points along a curve.

23. A method as recited in claim 22:
wherein said signed digit representations are represented with 0, 1 and -1 instead of a binary representation with 0 and 1; and
wherein joint weight is determined by the number of non-zero columns.

24. A method as recited in claim 22, wherein said generation of binary signed-digit representation comprises a Booth multiplication technique for twos complement binary numbers.

25. A method as recited in claim 22, wherein said recoding comprises replacing groups of signed binary digits according to one or more predetermined replacement patterns.

26. A method as recited in claim 25, wherein said predetermined replacement patterns for two integers comprises:
replacing 11 with 01, replacing 11 with 01, replacing 101 with 011, replacing 1o0 with oII, replacing oII with 101, and replacing 011 with 10I.

27. A method as recited in claim 22, wherein said curve comprises an elliptic curve and said cryptosystem utilizes elliptic curve cryptography (ECC).

28. A method as recited in claim 22, wherein said recoding is performed in combination with said scalar multiplication.

29. A method as recited in claim 28, wherein said combination of said recoding and said scalar multiplication reduces the amount of memory required in performing the cryptography.

30. A method as recited in claim 29, wherein said combination of said recoding and said scalar multiplication is performed in electronic circuit hardware.

31. A method as recited in claim 29, wherein said combination of said recoding and said scalar multiplication is performed in software, hardware, or a combination of hardware and software.

32. A method of computing a binary signed-digit representation of two integers g and h, each having L bits, comprising:
(a) converting binary representations of at least two integers g and h into Xl and X₂ according to: Xl =((gL - 0), (gL-2 - gL- 1 (90-gl),(0-go)) and X2=((k- -O),(k-2-k-,),...,(ho -k),(O-ho));
(b) recoding Xl and X₂ into Y, and Y2 using left-to-right replacement if decreased joint weight can be produced; and
(c) wherein said left-to-right replacement comprises replacing 1, -1 by 0, 1, replacing -1, 1 by 0, -1, replacing 1, 0, -1 by 0, 1, 1, replacing -1, 0, 1 by 0, -1, -1, replacing 0, -1, -1 by -1, 0,1, and replacing 0,1,1 by 1, 0, -1.

33. A method as recited in claim 32:
wherein said signed digit representations are represented with 0, 1 and -1 instead of a binary representation with 0 and 1; and
wherein the joint weight of g and h is determined by the number of non-zero columns when g and h are aligned in adjacent rows.

34. A method as recited in claim 32, wherein said conversions require only three signed-binary bits of memory for each integer.

35. A method as recited in claim 32, wherein the resultant joint weight is equivalent to that produced using joint sparse form (JSF) techniques.

36. A method as recited in claim 32, wherein integers g and h each comprise a binary integer of at least 160 bits.

37. A method of performing scalar multiplication within an elliptic curve cryptosystem, comprising:
(a) converting binary representations of at least two integers g and h into Xl and X₂ according to: Xl =((gL - 0), (go 2 - gL- 1 (90-gl),(0-go)) and X2=((k- -O),(k-2-k-,),...,(ho -k),(O-ho));
(b) recoding Xl and X₂ into Y, and Y₂ using left-to-right replacement if decreased joint weight can be produced;
wherein said left-to-right replacement comprises, replacing 1, -1 by 0, 1, replacing -1, 1 by 0, -1, replacing 1, 0, -1 by 0, 1, 1, replacing -1, 0, 1 by 0, -1, -1, replacing 0, -1, -1 by -1, 0,1, and replacing 0, 1, 1 by 1, 0, -1; and
(c) sequentially performing a scalar multiplication along an elliptic curve as each integer is converted.

38. A method as recited in claim 37:
wherein said signed digit representations are represented with 0, 1 and -1 instead of a binary representation with 0 and 1; and
wherein the joint weight of integers g and h is determined by the number of non-zero columns when g and h are aligned in adjacent rows.

39. A method as recited in claim 37, wherein said recoding of Xl and X₂ into Y, and Y₂ is configured to utilize only three signed-binary bits of memory for each integer.

40. A method as recited in claim 37, wherein the resultant joint weight is equivalent to that produced using joint sparse form (JSF) techniques.

41. A method as recited in claim 37, wherein integers g and h each comprise at least 160 binary bits.

42. A method as recited in claim 37, wherein said method is implemented in hardware, software, or a combination of hardware and software.

43. A method as recited in claim 37, wherein said method is implemented in hardware as a sequential circuit having bits of g and h as inputs with the most significant bits being input first.
